(19) United States
(12) Patent Application Publication
(10) Pub. No.: US 2016/0275460 A1
(43) Pub. Date: Sep. 22, 2016

(54) SYSTEMS AND METHODS FOR INSPECTING MOBILE DEVICES AND OTHER CONSUMER ELECTRONIC DEVICES WITH A LASER

(71) Applicant: ecoATM, Inc., San Diego, CA (US)

(72) Inventors: Jeffrey Ploetner, San Diego, CA (US); Mark Vincent Bowles, San Diego, CA (US)

(21) Appl. No.: 14/660,768

(22) Filed: Mar. 17, 2015

(51) Int. Cl. G06Q 10/00; G06Q 20/18

(52) U.S. Cl. CPC G06Q 10/30; G06Q 20/18

(57) ABSTRACT

Systems and methods for recycling electronic and/or other consumer electronic devices are disclosed herein. A kiosk configured in accordance with one embodiment of the technology includes a laser device, an imaging device, a processor operably coupled to the laser device and/or the imaging device, and a non-transitory computer readable medium having instructions stored therein that are executable by the processor. The laser device is configured to form a laser beam line across at least one exterior surface of the electronic device, the imaging device is configured to acquire an image of the laser beam line, and the instructions are executable by the processor to determine one or more physical attributes of the electronic device based at least in part on an evaluation of the laser beam line in the image.

### TECHNICAL FIELD

The present disclosure is directed generally to systems and methods for processing mobile devices and other consumer electronic devices at, for example, a consumer operated kiosk, and in particular, to systems and methods for inspecting such devices with a laser.

### BACKGROUND

Consumer electronic devices, such as mobile phones, laptop computers, notebooks, tablets, MP3 players, etc., are ubiquitous. Currently there are over 6 billion mobile devices in use in the world; and the number of these devices is growing rapidly with more than 1.8 billion mobile phones being sold in 2013 alone. By 2017 it is expected that there will be more mobile devices in use than there are people on the planet. In addition to mobile phones, over 300 million desk-based and notebook computers shipped in 2013, and for the first time the number of tablet computers shipped exceeded laptops. Part of the reason for the rapid growth in the number of mobile phones and other electronic devices is the rapid pace at which these devices evolve, and the increased usage of such devices in third world countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, the U.S. alone disposes of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Unfortunately, however, mobile phones and similar devices typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment. As an alternative to retailer trade-in or buyback programs, consumers can now recycle and/or sell their used mobile phones using self-service kiosks located in malls, retail stores, or other publically accessible areas. Such kiosks are operated by ecoATM, Inc., the assignee of the present application, and are disclosed in, for example, U.S. Pat. Nos. 8,463,646, 8,423,404, 8,239,262, 8,200,533, 8,195,511, and 7,881,965, which are commonly owned by ecoATM, Inc. and are incorporated herein by reference in their entireties.

When evaluating used mobile phones for possible purchase from consumers via, for example, a kiosk, it can be important to accurately determine the make and model of the phone, as well as the physical condition so that the phone can be accurately priced. Accordingly, improving the means available to determine these aspects of a phone can lead to more accurate pricing, and providing more accurate pricing can incentivize consumers to use such kiosks to dispose of their old electronic devices in an efficient and environmentally conscientious way.

### BRIEF DESCRIPTION OF THE DRAWINGS

FIG. 1 is an isometric view of a kiosk for reselling, recycling, and/or other processing of mobile devices and other consumer electronic devices configured in accordance with an embodiment of the present technology.

FIGS. 2A-2D are a series of views of a device inspection system of the kiosk of FIG. 1 configured in accordance with an embodiment of the present technology.

FIG. 3A-3C are a series of views depicting images of a mobile device acquired by the inspection system of FIGS. 2A-2D configured in accordance with embodiments of the present technology.

FIG. 4 is a representative flow diagram of a routine for processing mobile devices or other consumer electronic devices in accordance with an embodiment of the present technology.

FIG. 5 is a schematic diagram illustrating hardware and other components for implementing various aspects of the present technology.

FIG. 6 is a schematic diagram of a suitable distributed computing environment for implementing various aspects of the present technology.

### DETAILED DESCRIPTION

When purchasing and/or recycling a used electronic device (e.g., a used smart phone), it can be important for a purchaser to inspect the device to identify any issues that may affect the value. For example, when purchasing a mobile phone, it can be important to properly identify the phone and determine if the phone has been damaged, if the phone has significant wear and tear, or if the phone has been reported stolen. In the case of a transaction executed via a consumer-operated kiosk, carrying out this inspection can be significantly more challenging than it would be in the case of a person-to-person transaction. For example, consumer-operated kiosks typically require the user to enter information at a kiosk touchscreen or keypad to help identify the make and model of the mobile device. Additionally, in some kiosks, a camera is used to acquire one or more images of the device so that the kiosk can process the images to determine the identity of the device (e.g., the device make and/or model), as well as the presence of any damage to the device. In some cases, however, the image quality may be poor, and as a result it may be difficult to detect the dimensions and other features of the device. As a result, the kiosk may not be able to recognize or sufficiently identify a device based on the images. Additionally, the images may not show some types of damage to the device (e.g., hairline cracks in the screen). Accordingly, there is a risk that consumer-operated kiosks may not be able to properly identify same mobile devices and/or properly assess the physical condition of the devices.

Systems, devices, and methods configured in accordance with embodiments of the present technology can at least partially address one or more of the problems described above and/or other problems associated with conventional technologies whether or not stated herein. For example, self-service kiosks configured in accordance with at least some embodiments of the present technology include a laser device configured to project a laser beam line across at least one exterior surface of an electronic device, and an imaging device (e.g. a camera) configured to acquire an image of the laser beam line on the exterior surface. As described below, the kiosk can determine one or more physical attributes of the electronic device based at least in part on an appearance of the laser beam line in the image, and then identify, assess the value, and/or authenticate the electronic device based at least in part on the physical attributes.

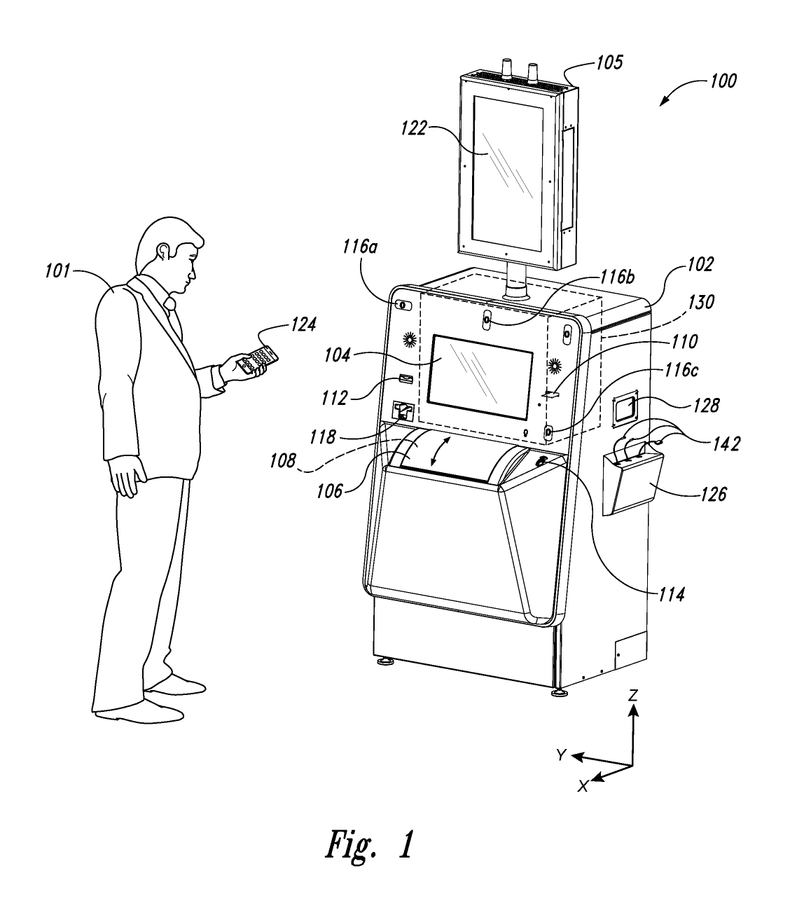

Certain details are set forth in the following description and in FIGS. 1-6 to provide a thorough understanding of various embodiments of the present technology. In other instances, well-known structures, materials, operations, and/or systems often associated with smartphones and other handheld devices, consumer electronic devices, lasers, computer hardware, software, and network systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile devices (e.g., smartphones) and other consumer electronic devices configured in accordance with the present technology. In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

As used herein, and for ease of reference, the term “processing” generally refers to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc. mobile phones and other electronic devices. Although many embodiments of the present technology are described herein in the context of mobile phones, aspects of the present technology are not limited to mobile phones and generally apply to other consumer electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger consumer electronic devices, such as desktop computers, TVs, game consoles, etc., as well smaller electronic devices such as Google Glass™, smart-watches, etc. The kiosk 100 and various features thereof can be at least generally similar in structure and function to the kiosks and corresponding features described in U.S. Pat. Nos. 8,463,646, 8,423,404, 8,239,262, 8,200,533, 8,195,511, and 7,881,965; and in U.S. patent application Ser. Nos. 12/573,089, 12/727,624, 13/113,497, 12/785,465, 13/017,560, 13/438,924, 13/753,539, 13/658,825, 13/733,984, 13/705,252, 13/487,299 13/492,835, 13/562,292, 13/658,828, 13/693,032, 13/792,030, 13/794,814, 13/794,816, 13/862,395, 13/913,408, 14/498,763, 14/500,739, 14/506,449, 62/059,129, 62/059,132, 62/073,840, and 62/073,847. All of the patents and patent applications listed in the preceding sentence are commonly owned by the applicant of the present application, and they along with any other patents or patent applications identified herein are incorporated herein by reference in their entireties.

In the illustrated embodiment, the kiosk 100 includes a housing 102 that is approximately the size of a conventional vending machine. The housing 102 can be of conventional manufacture from, for example, sheet metal, plastic panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (LCD)) or light emitting diode (LED) display screen, a projected display (such as a head-up display or a head-mounted device), and so on for providing information, prompts, etc. to users. The display screen 104 can include a touchscreen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a fingerprint reader 114, and one or more cameras 116 (e.g., digital still and/or video cameras, identified individually as cameras 116a-c). The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices may include a touchpad, a pointing device, such as a mouse, a joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 105 having a display screen 122 for displaying marketing advertisements and/or other video or graphical information to attract users to the kiosk.

A sidewall portion of the housing 102 can include a number of conveniences to help users recycle or otherwise process their mobile phones. For example, in the illustrated embodiment the kiosk 100 includes an accessory bin 128 that is configured to receive mobile device accessories that the user wishes to recycle or otherwise dispose of. Additionally, the kiosk 100 can provide a free charging station 126 with a plurality of electrical connectors 142 for charging a wide variety of mobile phones and other consumer electronic devices. The kiosk 100 further includes a door 106 located beneath the display screen 104. The door 106 is configured to automatically retract so that a user 101 can place an electronic device, such as a mobile device 124 (e.g., a smart phone), within an inspection area 108 for automatic inspection by an inspection system 130 (shown schematically by broken lines).

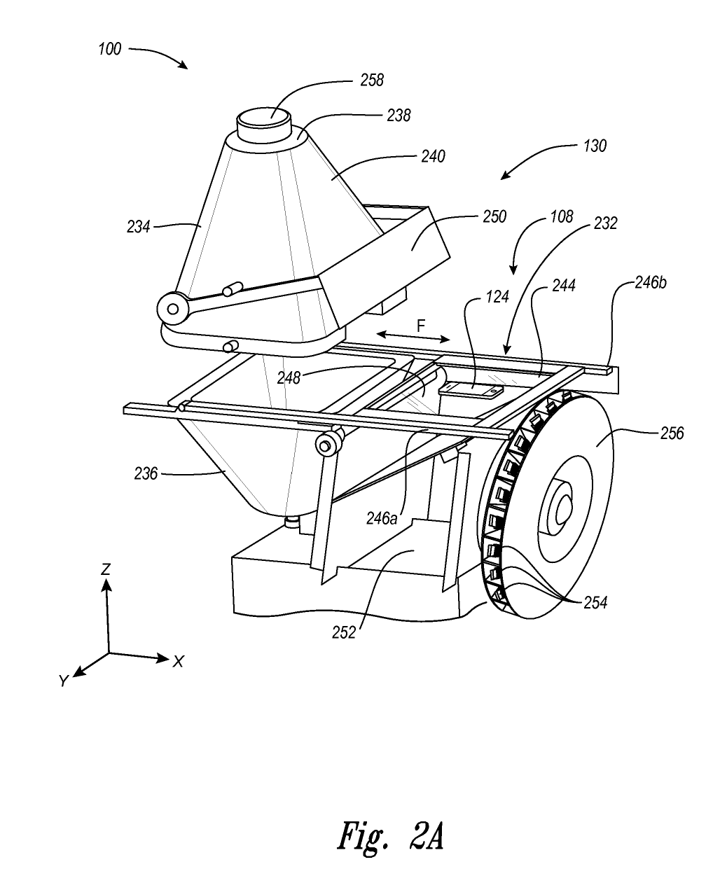

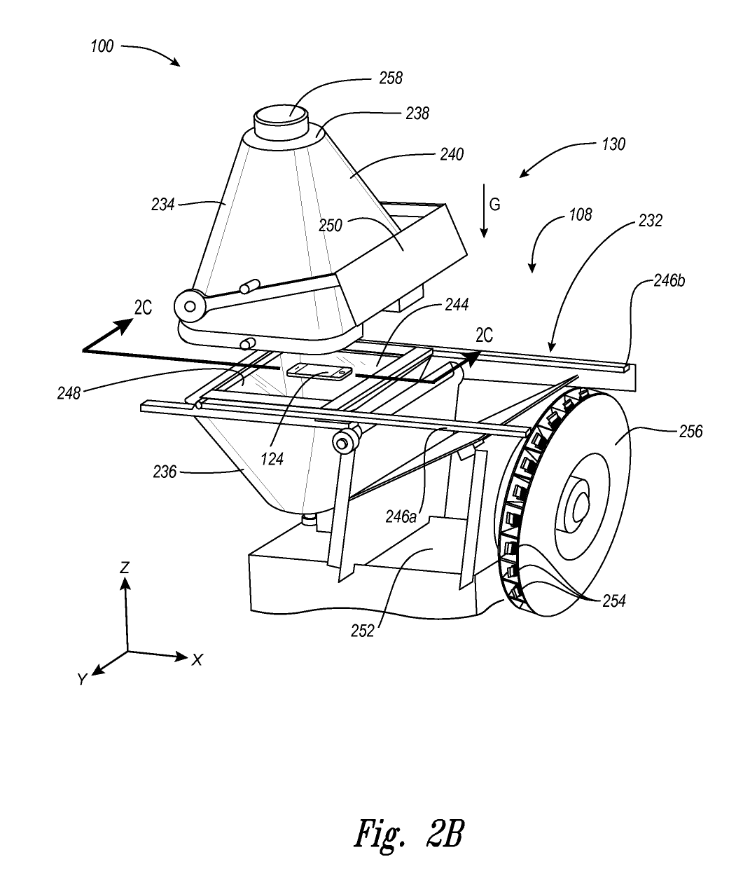

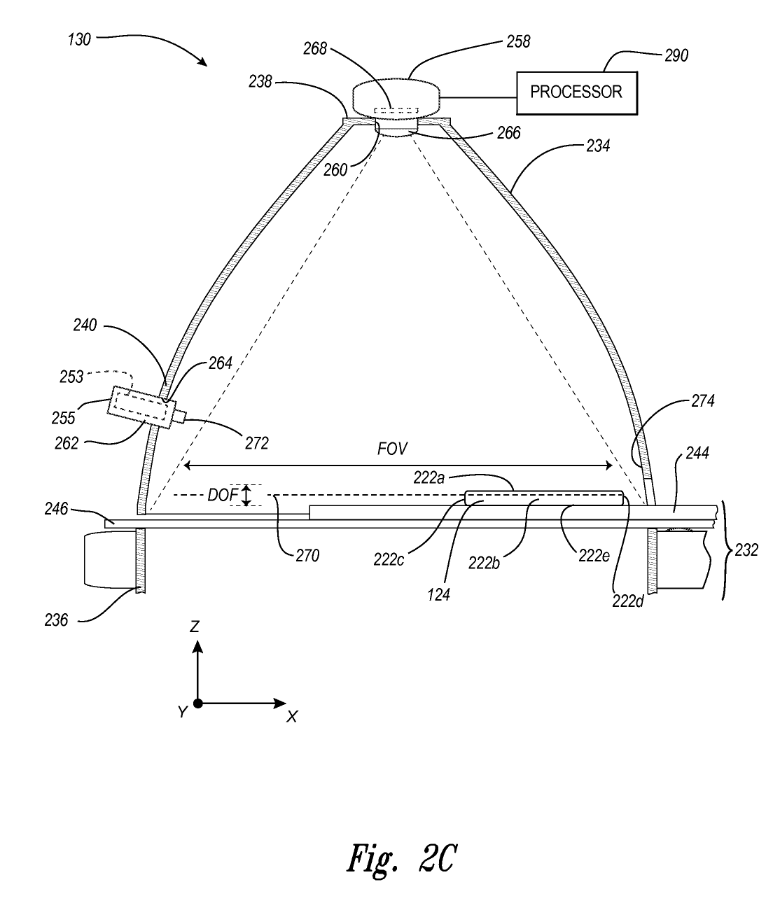

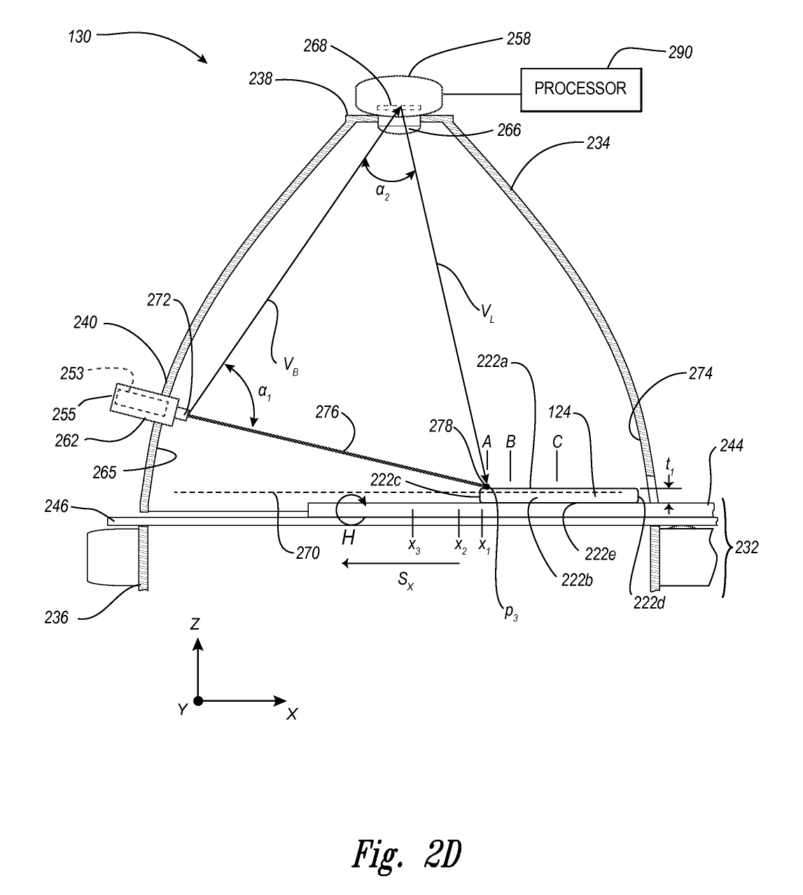

FIGS. 2A and 2B are isometric views of the kiosk 100 with the housing 102 removed to illustrated the inspection system 130 configured in accordance with an embodiment of the present technology. Referring to FIGS. 2A and 2B together, the inspection system 130 includes a device transporter assembly 232 (the “transporter assembly 232”), an upper chamber 234 located generally above the transporter assembly 232, and a lower chamber 236 located generally below the upper chamber 234. In the illustrated embodiment, the transporter assembly 232 can include a carrier or inspection plate 244 carried on a pair of parallel mounting tracks 246a, b and operably coupled to a drive assembly (not shown). The inspection plate 244 includes an upper surface 248 onto which the mobile device 124 can be placed when the access door 106 (FIG. 1) is opened. The inspection plate 244 can be transparent, or at least partially transparent (e.g., formed of glass, Plexiglas, etc.) to enable the various surfaces of the mobile device 124 to be imaged (e.g., photographed) and/or otherwise optically evaluated from bottom viewing angles. The drive assembly can include, for example, a toothed rack and pinion gear that is driven by, e.g., an electric motor and is operably engaged with the inspection plate 244 to move the plate forward and aft on the mounting tracks 246 (as shown by arrow F) between, e.g., a first position (FIG. 2A) directly behind the access door 106, and a second position (FIG. 2B) in which the inspection plate 244 is positioned between the upper and lower chambers 234 and 236. When the inspection plate 244 is at the second position, the upper chamber 234 can translate downwardly (as shown by arrow G) to generally enclose the mobile device 124 between the upper chamber 234 and the lower chamber 236.

In at least some embodiments, the inspection system 130 can further include components for performing an electrical inspection of the mobile device 124. For example, the inspection system 130 can include a plurality of electrical connectors 254 (e.g., approximately 25 connectors) that can be individually withdrawn from a removable connector carrier 256. In the illustrated embodiment, the connector carrier 256 is configured to automatically rotate about a central axis to position an appropriate one of the connectors 254 adjacent to the mobile device 124 when the device 124 is placed on the inspection plate 244. The electrical connectors 254 include a plurality of interchangeable connector types (e.g., USB, firewire, lightning connectors) configured to be connected to the mobile device 124 by the user to provide power and/or exchange data with a variety of different mobile phones and/or other electronic devices. The kiosk 100 can electrically inspect the mobile device 124 over the electrical connector 254, such as to extract information (e.g., identifying information, specifications, inventories of components, etc.) from the mobile device, to test the device for authenticity, and/or to test the device for condition. The electrical inspection conducted via the electrical connector 254 can include one or more of the methods and/or systems described in detail in the commonly owned patents and patent applications identified herein and incorporated by reference in their entireties.

FIG. 2C is a cross-sectional side view of the inspection system 130 taken generally along line 2C-2C in FIG. 2B after the upper chamber 234 has been lowered to generally enclose the mobile device 124 therein. As shown in FIG. 2C, the inspection system 130 further includes at least one imaging device, such as a camera 258. In other embodiments, suitable imaging devices can include other types of optical detectors in addition to or lieu of a camera. For example, in one embodiment described in greater detail below, the inspection system 130 can include Lidar sensors configured to provide raw imaging data (e.g., sensor data) to the kiosk processor 290.

In the illustrated embodiments, the camera 258 is installed in a first aperture 260 in an upper wall portion 238 of the upper chamber 234, and a light projector, such as a laser device 262 (e.g., a laser projector), installed in a second aperture 264 in a rear sidewall portion 240 of the chamber 234. As shown, the camera 258 includes a lens 266 that generally faces toward the lower chamber 236, and an image sensor 268 (e.g., a CCD, CMOS, and/or sCMOS sensor) optically coupled to the lens 266. In one embodiment, the image sensor 268 is configured to detect light in the visible portion of the spectrum. In other embodiments, the image sensor 268 can detect light in the infrared (IR), near IR, and/or UV portion of the spectrum. For example, the image sensor can detect UV light to read hidden codes or information, such as a model, serial, and/or International Mobile Equipment Identity (IMEI) number, printed on a surface 222 of the mobile device 124, or on a sticker (not shown) placed on the surface 222 by the manufacturer or device vender to prevent fraud. In other embodiments the image sensor can detect IR light to measure the amount of heat generated by the mobile device 124 during electrical inspection.

The lens 266 is selected to provide a suitable field of view (FOV) and depth of focus (DOF) at a plane of focus 270 located toward the base of the upper chamber 234. The FOV and DOF can be selected to acquire sufficiently sharp images of one or more surfaces on top, lateral, front, rear, and/or bottom sides 222a-222e, respectively, of the mobile device 124 at or near the plane of focus 270. In one embodiment, the camera 258 can include a focusing element (not shown) configured to automatically raise/lower the plane of focus 270 and/or widen/narrow the DOF based on the size of the mobile device 124 that is being inspected. For example, such focusing optics can lower the plane of focus 270 and/or narrow the DOF for thin-profile mobile devices (e.g., an iPhone 6 plus), and raise the plane of focus 270 and/or widen the DOF for relatively thicker devices (e.g., an iPhone 3s).

In operation, the camera 258 is configured to output imaging data acquired by the image sensor 268. As described in greater detail below, the imaging data can be processed by a kiosk processor 290 (shown schematically), such as a central processing unit (CPU) of the kiosk 100 and/or an intermediary processor. In one embodiment, the camera 258 can provide raw imaging data to the kiosk processor 290. In another embodiment, the camera 258 can format the raw imaging data into an image file format (e.g., a JPEG format, graphic interchange format (GIF), tag image file format (TIFF), portable network graphics (PNG) format, or bitmap (BMP) format, etc.) and/or a video format (e.g., a MPEG format, audio video interleaved (AVI) format, windows video format (WMV), etc.).

In the illustrated embodiment, the laser device 262 includes a laser generator 253, within a housing 255 and optically coupled to an output portion 272 (e.g., a lens) that is directed generally toward a forward side 274 of the upper chamber 234. The laser generator 253 can include, for example, one or more light sources for single color projection or multi-color projection. In some embodiments, the laser generator 253 can include, for example, a semiconductor laser, a laser diode, a gas laser, or other suitable light emitting device configured to produce a beam of generally coherent light when the laser device 262 is powered on. In one embodiment, for example, the laser generator 253 is configured to produce a laser beam having a discrete wavelength or a narrow range of discrete wavelengths in the visible spectrum (e.g., wavelengths in the red, blue, or green portions of the spectrum). The output portion 272 can include, for example, a powell lens configured to stretch a beam of laser light (e.g., a pencil beam) into a uniformly illuminated line that fans outwardly from the output portion 272 generally toward the inspection plate 244 when it is moved beneath the camera 258. In some embodiments, the output portion 272 can include one or more lenses configured to project multiple beam lines, such as parallel beam lines and/or perpendicular beam lines (e.g., cross hairs). In other embodiments, the output portion 272 can be configured to produce laser beams that form a pattern of laser dots (e.g., a dot matrix pattern), dashes, and/or dashes and dots on the exterior surfaces of the mobile device 124.

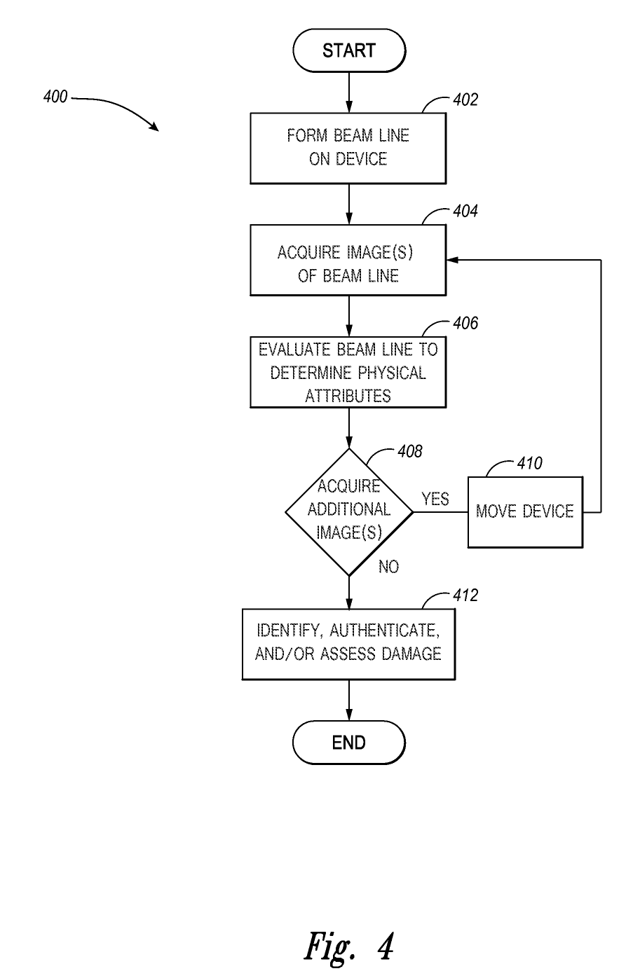

FIG. 2D is a cross-sectional side view of the inspection system 130 after the laser device 262 has been powered on so that the output portion 272 is projecting a laser beam 276. When the laser beam 276 strikes the mobile device 124 as shown, it forms a beam line 278 on one or more exterior surfaces on the mobile device at a first location A generally on the top side 222a. In this example, the laser device 262 is oriented at a beam angle α₁ defined by the laser beam 276 and a baseline vector V_{B} extending between the output portion 272 and the image sensor 268. In one embodiment described below with reference to FIG. 4, the kiosk processor 290 can triangulate the first location A of the beam line 278 and/or the locations of other points along the beam line 278 by use of the beam angle α₁ and the baseline vector V_{B}.

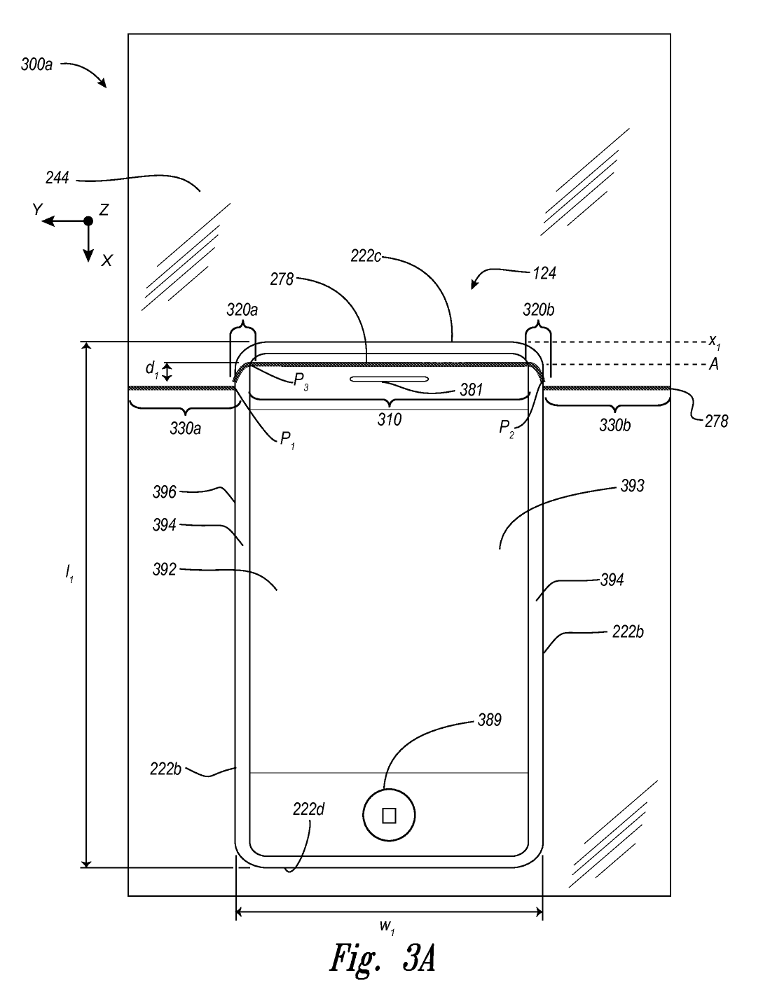

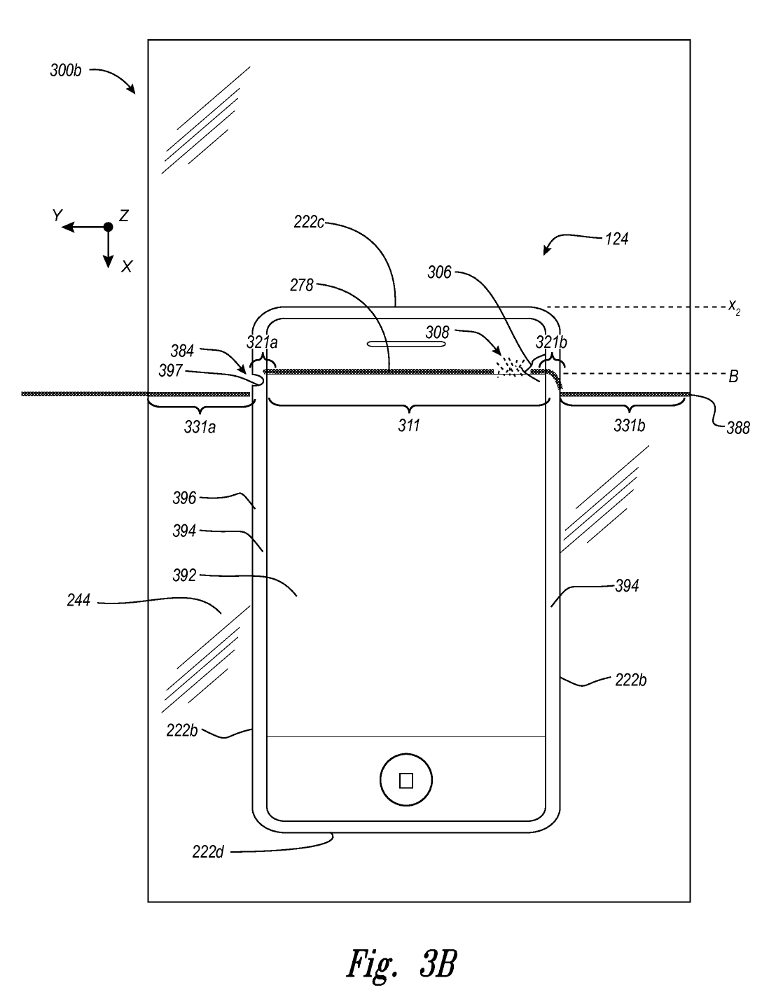

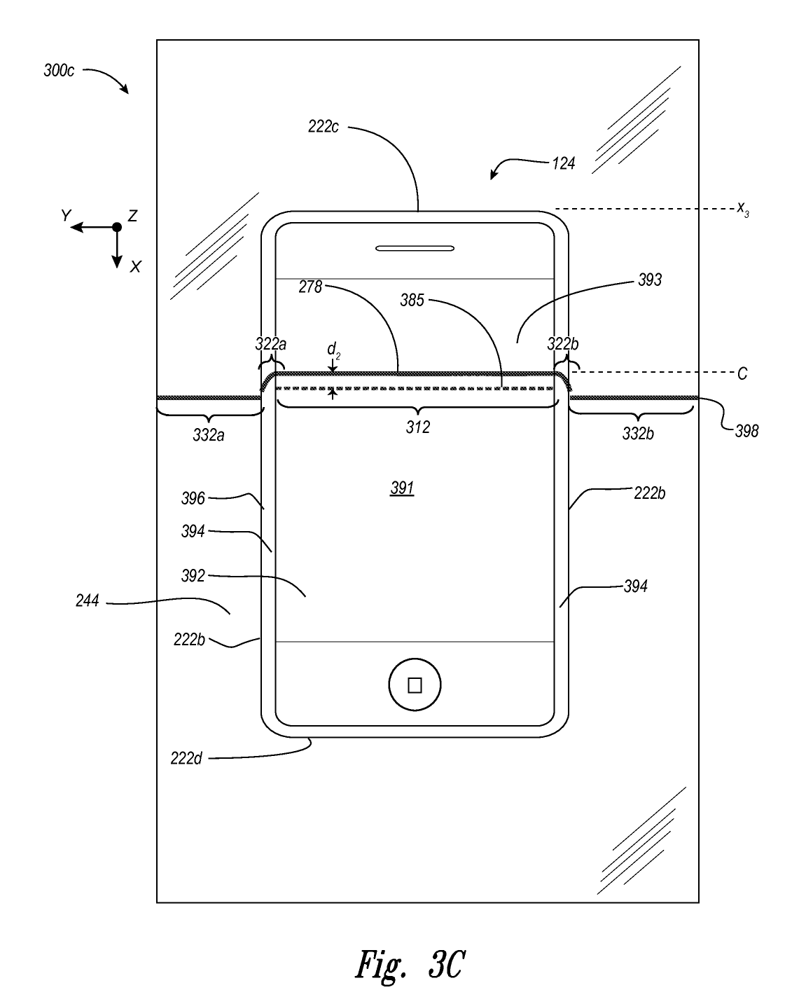

The transporter assembly 232 is configured to move the inspection plate 244 back and forth in the X-axis directions within the upper chamber 234 when the mobile device is positioned on the plate 244. For example, the transporter assembly 232 can move the front side 222c of the mobile device 124 from a first position x₁ within the upper chamber 234 to other positions within the chamber, such as second and third positions x₂ and x₃, respectively, located closer to a rear sidewall portion 240 of the chamber 234, or any number of other positions along the X-axis within the chamber 234. As described below with reference to FIGS. 3B and 3C, when the mobile device 124 is at the second position x₂, the laser beam 276 strikes the top side 222a at a second location B, and when the mobile device 124 is at the third position x₃, the laser beam 276 strikes the top side 222a at a third location C. In one embodiment described below with reference to FIG. 4, the transport assembly 232 is configured to move the mobile device 124 through the camera field of view and the beam path of the laser 276 at a predetermined speed S_{X}.

In at least some embodiments, the transporter assembly 232 can also be configured to move the mobile device 124 within the chamber in the Y- and/or Z-axis directions, in addition to or lieu of the X-axis directions. In these and other embodiments, the transporter assembly 232 can be configured to partially or completely rotate the mobile device 124 about an axis (e.g., about the Y and/or Z-axis). For example, in one embodiment the transporter assembly 232 can tilt the inspection plate 244 so as to rotate mobile device 124 relative to the plane of focus 270 (as shown by arrow H). When the mobile device 124 is tilted or rotated in such a manner, the laser beam 276 can strike one or more of the lateral, front, rear, and/or bottom sides 222b-222e more directly and/or enable the camera 258 to obtain a better or different view of these sides of the device.

In operation, the laser device 262 projects the laser beam 276 onto the mobile device 124, and the camera 258 acquires images (e.g., imaging data) of the beam line 278 formed on the mobile device 124. The kiosk processor 290 can evaluate the appearance of the beam line 278 in the images using one or more computer image processing algorithms (e.g., edge detection algorithms) that can determine various physical attributes of the mobile device based on the shape (e.g., curvature), intensity, and other aspects of the beam line 278 shown in the acquired image(s). As described in more detail below, the kiosk processor 290 can use the physical attributes to identify, authenticate, determine the value, and/or otherwise evaluate the mobile device 124 for processing the device 124 received from the user.

In other embodiments, the inspection system 130 can include other types and/or configurations of imaging devices and/or laser devices. For example, in one embodiment, the inspection plate 244 may be held stationary and the laser device 262 can be configured to scan or raster the laser beam 276 across the exterior surfaces of the mobile device 124. In another embodiment, the camera 258 may be mounted to a mechanical arm, bridge, or the like configured to move the camera 258 in an arc over or circle around the mobile device 124. Although not shown in the illustrated embodiment for purposes of clarity, the inspection system 130 can also include camera and laser devices installed in the lower chamber 236 and used to inspect, e.g., the bottom side 222e of the mobile device 124. The inspection system 130 can also include one or more light sources installed in the upper chamber 234 and/or lower chamber 236 and configured to provide illumination for facilitating device imaging. In addition or alternately, the camera 258 can include an integrated light source. In some embodiments, the inspection system 130 can be configured to enhance image contrast (e.g., beam line contrast) by temporarily depositing a contrast enhancement material on an exterior surface of the mobile device 124, such as the touchscreen surface, or other generally reflective, shiny, and/or dark surfaces of the mobile device 124. In one embodiment, the inspection system 130 can include an aerosol dispenser device (not shown) configured to dispense a fine grain powder generally over at least a portion of the mobile device 124 before or during device inspection. When device inspection is complete, the inspection system 130 can remove the powder using, e.g., an internal blower and/or exhaust system (not shown). In one embodiment, the contrast enhancement material can include a White Power Spray, available from Proto3000 of 171 Marycroft Avenue, Ontario, Canada.

FIG. 3A-3C are a series of views depicting first, second, and third images 300a-c of the mobile device 124 acquired by acquired by the camera 258 configured in accordance with selected embodiments of the present technology. More specifically, the images 300a-c show the laser beam 276 striking or intersecting the mobile device 124 and forming a beam line at the first through third locations A-C (FIG. 2D), respectively. Referring first to FIG. 3A, the first image 300A shows the beam line 278 at the first location A and as having a center beam line segment 310 that extends across a cover plate 392 of the mobile device and curved beam line segments 320a, b at opposite ends of the center segment 310 and extending across opposite edge portions 394 of a device case 396. The beam line 278 also includes outer beam line segments 330a, b extending away from a corresponding one of the curved segments 320 and across the inspection plate 244 at opposite sides of the device edge portions 394. In the illustrated embodiment, the center beam line segment 310 and the outer beam line segments 330a, b are generally linear, as a result of the cover plate 392 and the inspection plate 244 having generally flat surfaces. The curved beam line segments 320a, b, however, are curved because the outer edge portions 394 of the device are not flat, but beveled. Additionally, the center beam line segment 310 is offset from the outer beam line segments 330a, b by a first lateral or horizontal offset distance d₁, as a result of the laser device 262 (FIG. 2D) having a non-zero beam angle α₁ relative to the camera 258 (FIG. 2D), which causes the laser beam 276 to strike the cover plate 392 before it strikes the inspection plate 244. The offset distance d₁ extends parallel to the surface of the inspection plate 244.

As described in greater detail below with reference to FIG. 4, the inspection system 130 can process the first image 300a, and in particular the appearance of the beam line in the image 300a, to determine, e.g., the location of various device features, such as the lateral sides 222b, a touchscreen region 393, and other device features (e.g., a device button 389 or a speaker perforation 381 in the cover plate 392). In addition or alternately, the inspection system 130 can similarly determine the dimensions of such features and/or the overall dimensions of the mobile device 124, such as a width w₁, a length l₁, and/or a thickness t₁ (FIG. 2D), as well as other physical attributes of the mobile device 124 (e.g., the presence of any defects or damage).

FIG. 3B shows the second image 300b acquired by the camera 258 of the laser beam 276 when it strikes the second location B on the mobile device 124. Similar to the first image 300a, the second image 300b shows a beam line 388 having a center beam line segment 311, curved beam line segments 321a, b, and outer beam line segments 331a, b. However, now one of curved segments 321a includes a discontinuity region 384 caused by a dented region 397 in the left edge portion 394 of the device case 396. Also, the center segment 311 includes a scatter region 308 caused by a scratch or a crack 306 in the cover plate 392. As described in greater detail below, the kiosk processor 290 (FIG. 2D) can evaluate the beam line to detect for discontinuities, beam scatter, and other anomalies in a beam line to detect the presence of damage.

FIG. 3C shows the third image 300c acquired by the camera 258 of the laser beam 276 when it strikes the second location C on the mobile device 124. Similar to the first and second images 300a, b, the third image 300c shows a beam line 398 having a center beam line segment 312, curved beam line segments 322a, b, and outer beam line segments 332a, b. In this example, however, the laser beam 276 also produces a reflected beam line 385 in the touchscreen region 393. The reflected beam line 385 corresponds to a portion of the laser beam 276 that transmits through the transparent portion of the cover plate 392 and reflects off a reflective surface 391 of an underlying LCD panel (not shown). In some instances, the reflected beam line 385 can be used to detect whether the mobile device 124 is a counterfeit device. For example, a counterfeit device may include an inexpensive mobile device case or shell, which makes it look like a genuine device, but in fact it may lack the internal LCD display panel or other internal components of the genuine device. In such counterfeit devices, the reflected beam line 385 might not appear in the image 300c, or it may appear differently than expected, thereby indicating that the device is a counterfeit.

As further shown in FIG. 3C, the reflected beam line 385 can be offset from the center beam line segment 312 on the cover plate 392 by a second lateral or horizontal offset distance d₂. In some embodiments, the second offset distance d₂ can correspond to the size of a gap (e.g., an air gap; not shown) between the internal LCD display panel and the cover plate 392. In some instances, the size of the gap can be unique to a particular model and/or make of a device based, e.g., on the arrangement of the cover plate 392, the LCD display panel, and/or other components within the device. In general, a large gap will produce a large offset distance d₂, and a small gap will produce a relatively smaller offset distance d₂. In some embodiments, the offset distance d₂ can be used as unique device signature to facilitate device identification and/or authentication. For example, the kiosk processor 290 (FIG. 2D) can identify and/or authenticate a device by comparing a measured offset distance d₂ to values stored in database representing an expected or known offset distance for a particular model and/or make of a device.

FIG. 4 is a flow diagram illustrating a routine 400 that can be carried out by the kiosk processor 290 to facilitate the efficient recycling, selling, and/or other processing of mobile devices and other consumer electronic devices, such as the mobile device 124. Referring to FIG. 1, in one embodiment the routine 400 can begin after a user wishing to sell a used mobile phone, such as the mobile device 124, approaches the kiosk 100 and identifies the type of device the user wishes to sell by, for example, selecting one or more buttons on a keypad or touchscreen in response to prompts on the display screen 104. In some embodiments, the user may be prompted to place his or her identification (e.g., a driver's license) in the ID scanner 112 and provide a thumbprint via the fingerprint reader 114. As a fraud prevention measure, the kiosk 100 can be configured to transmit an image of the driver's license to a remote computer screen, and an operator at the remote computer can visually compare the picture (and/or other information) on the driver's license to the person standing in front of the kiosk 100 as viewed by one or more of the cameras 116a-c to confirm that the person attempting to sell the mobile device 124 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicate that the person selling the phone presents a fraud risk, the transaction can be declined.

Next, the user may be prompted to remove any cases, stickers, or other accessories from the device 124 so that it can be accurately evaluated. Additionally, the kiosk 100 may print and dispense a unique identification label (e.g., a small adhesive-backed sticker with a QR code, barcode, etc.) from the label outlet 110 for the user to adhere to the back of the mobile device 124. After this is done, the door 106 retracts allowing the user to place the mobile device 124 onto the inspection plate 244 (FIG. 2A) in the inspection area 108. The door 106 then closes and the inspection plate 244 moves the mobile device 124 under the upper chamber 234 as shown in FIG. 2B. The upper chamber 234 then moves downwardly to generally enclose the mobile device 124 between the upper and lower chambers 234 and 236 as shown in FIG. 2C. The inspection system 130 can then perform a visual inspection of the mobile device 124 to determine the make, model, and/or condition.

Returning to FIG. 4, in block 402 the routine 400 powers on the laser device 262 (FIG. 2D) and outputs a laser beam 276 (FIG. 2D) that forms an illuminated beam line on the mobile device 124. In block 404, the routine 400 acquires one or images (or imaging data) of the beam line 278 formed on the mobile device 124 as described above with references to FIGS. 3A-3C. In some embodiments, the routine 400 can acquire pixel-based and/or vector-based digital images and/or video images showing the beam line 278 formed on, e.g., the first location A (FIG. 3A), the beam line 388 formed on the second location B (FIG. 3B), the beam line 398 formed on the third location C (FIG. 3C), and/or beam lines formed on other locations on the device 124.

In block 406, the routine 400 evaluates the appearance of the laser beam line in an acquired image to determine the physical attributes of the mobile device 124. In at least some embodiments, the kiosk processor 290 can evaluate the beam line using one or more image processing algorithms. Such image processing algorithms can include, for example, edge detection algorithms (search-based and/or zero-crossing-based edge detection algorithms) and/or other suitable image processing algorithms known in the art. For example, in one embodiment the routine 400 can use an edge detection algorithm to locate the laser beam line 278 by identifying the points (e.g., pixels) in an image at which the image brightness and/or color changes sharply. For example, in the case of a red laser beam, the routine 400 can detect pixels having a wavelength in the red portion of the spectrum (e.g., wavelengths in the range of about 620 nm to about 750 nm) and which produces a sharp contrast against black, white, silver, or other color(s) of a typical device casing. In some embodiments, the inspection system 130 can include multiple laser devices that produce different wavelength laser beams (e.g., green laser beams and red laser beams). In such embodiments, the routine 400 can select an appropriate wavelength laser beam depending on, e.g., the color of the exterior of the mobile device. For example, if the mobile device 124 has a red case 396, the routine 400 can select, e.g., a green laser beam rather than a red laser beam to enhance the contrast between the laser beam and the device case 396.

The routine 400 can also use image processing algorithms to detect for discontinuities, beam scatter, and other anomalies in the laser beam line indicative of damage. In one embodiment, if the routine 400 detects that the beam line has a substantial number of pixels missing from one of the beam line segments of a beam line this can be indicative of a discontinuity, which in turn can be indicative of damage. For example, as described above with reference to FIG. 3B, the discontinuity 384 in the left curved segment 320a is caused by the dented region 397 in the device case 396. In another embodiment, if the routine detects a reduced density of pixels in one or more of the beam line segments, this can be indicative of beam scatter, which can also be indicative of damage. For example, as described above with reference to FIG. 3C, the scatter region 308 in the center segment 310 is caused by the crack 306 in the cover plate 392.

In addition or alternately, the routine 400 can implement image processing algorithms to detect changes in slope or transitions between the various segments of a beam line. In one embodiment, the routine 400 can detect transition points in the beam line to determine a location or relative location of one or more features of the mobile device 124. For example, the routine 400 can detect transition points to determine the location of the lateral sides 222b of the device case 396 (FIG. 3A), the edges of the touchscreen region 393 (FIG. 3A), the edges of the cover plate 392 (FIG. 3A), and/or other device features, such as the device button 389 or the speaker perforation 381 in the cover plate 392. Referring to FIG. 3A, in one embodiment the routine 400 can determine the location of the lateral sides 222b of the device case 396 by detecting a first transition point P₁ between the left curved segment 320a and the left outer segment 330a, and a second transition point P₂ between the right curved segment 320b and the right outer segment 330b. In a related embodiment described below, the routine 400 can measure the distance between the first and second transition points P₁ and P₂ to determine the width w₁ of the mobile device 124. In additional or alternate embodiments, the routine 400 can detect other transition points in the beam line to detect the locations of other device features and/or dimensions. For example, in one embodiment the routine 400 can detect a third transition point P₃ between the left curved segment 320a and the center segment 310 of the beam line 278 shown in FIG. 3A. As described below, the routine 400 can use the first and third transition points P₁ and P₃ to measure the thickness t₁ of the mobile device 124.

In general, digital imaging techniques that rely on edge detection algorithms to automatically detect features in images (e.g., photographs or video images) can be hampered when edge segments in the image are obscured (due, e.g., to low contrast in the image) or when false edge segments are detected (due, e.g., to blur in the image). This can often lead to inaccuracies in image processing and/or can require the use of more computationally intensive algorithms. The present technology, however, can address these and other limitations in imaging processing, enabling the features of the mobile device to be more readily detected. For example, the laser beam line is relatively brighter than other non-coherent light (e.g., background light) reflected off of the mobile device. Additionally, the laser beam 276 has a discrete wavelength or a narrow range of discrete wavelengths, which makes it easier to discern the laser beam over other reflected light having broad range of wavelengths. As a result, image processing as described herein can be carried out with image processing algorithms that are generally less computationally intensive. Further, because the laser beam line has a greater intensity than the reflected light, the beam line 278 is less prone to being obscured by shadows in the image, low contrast, and/or blurring. Additionally, in certain embodiments, only a subset of pixels associated with the beam line may be analyzed, further reducing the computational complexity of image processing, and increasing inspection speed.

In some embodiments, the routine 400 can measure the distance between transition points by first calculating the coordinates of transition points of interest, and then measuring the distance between the calculated coordinates. In one embodiment, the routine 400 can use triangulation to determine the coordinates of a particular transition point. For example, referring to FIG. 2D, the routine 400 can determine the coordinates of the third transition point P₃ by deriving a location vector V_{L} that extends from the image sensor 268 to the third transition point P₃. In one embodiment, the location vector V_{L} can be derived based on the baseline vector V_{B}, the beam angle α₁, and a camera angle α₂ defined between baseline vector V_{B} and the location vector V_{L} as shown in equation 1:

V_{L}=V_{B}(sin α₁)(sin α₂)/sin(α₁α₂) (1)

In a related embodiment, the routine 400 can measure the thickness t₁ of the mobile device 124 by measuring the difference in Z-axis height between the third transition point P₃ and the first transition point P₁.

Referring again to FIG. 4, at decision block 408 the routine 400 determines if additional images of the beam line are required to sufficiently inspect the mobile device 124. If so, the routine 400 proceed to block 410 and moves the mobile device 124 via, e.g., the device transporter assembly 232 (FIG. 2A). For example, in one embodiment the routine 400 can move the device 124 forward (in the −X direction in FIG. 2D) to move the beam line 278 from the first location A shown in FIG. 3A to the second location B shown in FIG. 3B. In some embodiments, the routine 400 can acquire a series of, e.g., 5, 10, 50, 100, or more images to thoroughly inspect the entire mobile device 124 for damage, to detect certain features, and/or to detect the dimensions of the device or its features. In these and other embodiments, the routine 400 can carry out the evaluation of the beam line in block 406 while simultaneously moving the mobile device 124 through the beam path of the laser device 262 and the field of view of the camera 258. Referring to FIG. 2D, in one embodiment the routine 400 can detect the length l₁ of the mobile device 124 by moving the device 124 at the constant predetermined speed S_{X} and measuring the elapsed time Δt between when the laser 276 first strikes the outermost edge at the front side 222c of the device 124 and a later time at which the laser 276 strikes the outermost edge at the rear side 222d of the device. In such an embodiment, the length l₁ of the device can be calculated based on equation 2 as follows:

l₁=S_{X}Δt (2)

In a related embodiment, the routine 400 can produce a 3D profile (e.g., a 3D model and/or map) of the mobile device 124 based on the detected physical attributes. For example, in some embodiments the routine 400 can construct or create a 3D model based on the detected dimensions of the mobile device 124. The 3D model can accurately show overall size and shape of the mobile device 124, as well as its various device features, such as the touchscreen, the battery cover, a connector port (e.g., a USB port), a device button, and/or casing perforations for a speaker, microphone, light emitting diode (LED), etc. In addition or alternately, the 3D model can depict a material profile, including the exterior surface textures of the mobile device 124. In one embodiment, the routine 400 can detect certain surface textures based on the amount of detected beam scatter. For example, the routine 400 may detect a smooth surface (e.g., the touchscreen surface) at locations where there is negligible beam scatter, but a textured surface (e.g., a brushed-nickel surface) at locations where there is a relatively larger, yet uniform amount of beam scatter.

In certain embodiments, the routine 400 can create a 3D profile using alternate imaging and/or sensing techniques. For example, in one embodiment, the routine 400 can use Lidar sensing techniques. Such techniques can measure distance by illuminating a target with a laser and analyzing the reflected light with sensors. In particular, Lidar techniques measure the time it takes for a reflected light signal to return to the sensors, which can then be used to detect the distance between the laser device 262 (FIG. 2C) and target locations along the beam line 278 (FIG. 2D). Accordingly, the routine 400 can use Lidar-based scanning to detect device dimensions, device features, material profiles, and/or other physical attributes, such as one or more of the physical attributes described above. In at least some embodiments, the routine 400 can carry out such detection in lieu of beam triangulation (e.g., the beam detection at block 406). In these and other embodiments, Lidar sensors can produce data that the routine 400 can use to create a 3D profile without the assistance of the camera 258, and thus the camera 258 may be omitted in some cases. In some embodiments, one or more Lidar sensors can be installed in the inspection system 130 (e.g., in the upper chamber 234 and/or lower chambers 236; FIG. 2B), and the laser device 262 can be a Lidar scanner. For example, in one embodiment the laser device 262 can include a Lidar laser scanner (e.g., model nos. TiM551, LMS111, or LMS511) available from SICK AG of Waldkirch, Germany, and Lidar sensors (e.g., model nos. OPR20G-RB111517, RB317537, RB417537, or RB517537A01), also available from SICK AG.

In some embodiments, the kiosk 100 perform an electrical inspection stage after block 408. Referring Figure to FIG. 2A, in such embodiments the transporter assembly 232 can return the mobile device 124 to a location behind the access door 106 (FIG. 1), and the connector carrier 256 can automatically rotate an appropriate one of the connectors 254 into position adjacent the inspection plate 244. The door 106 can then open, and the user can then be instructed (via, e.g., the display screen 104) to withdraw the connector 254 (and its associated wire) from the connector carrier 256, plug the connector 254 into the corresponding port (e.g., a USB port) on the mobile device 124, and reposition the mobile device 124 on the inspection plate 244. After doing so, the door 106 once again closes and the kiosk 100 performs an electrical inspection of the device to further evaluate the mobile device 124. For example, as described above, electrical evaluation can extract certain information (e.g., identifying information) from the electronic device, test the electronic device for authenticity, and/or test the electronic device for electrical condition. In some embodiment, the electrical evaluation can be used in combination with the visual inspection to identify, authenticate, and/or otherwise assess the mobile device 124.

In block 412 the routine 400 identifies, authenticates, and/or assesses the physical condition the mobile device 124 based at least in part on the one or more physical attributes detected in block 406. For example, the routine 400 can identify the model and/or make of the mobile device based on the overall device dimensions (e.g., the length, width, and/or thickness), the dimensions of certain device features (e.g., the device button, the touchscreen region, etc.), and/or the absolute and/or relative locations of certain device features. For example, in some embodiments the routine 400 can query a local or remote database to look up the make and/or model of the mobile device by comparing the measured physical attributes to reference quantities corresponding to the known attributes of a particular make and/or model of a mobile device. In one embodiment, the routine 400 can compare the measured width, length, and/or thickness of the device under inspection to corresponding dimensions of a known device to determine the device identity. For example, if the measured dimensions match a set of dimensions associated with a known device, the routine 400 can then establish or verify the identity of the device under inspection. In these and other embodiments, the routine 400 can authenticate the device 124 based on the detected physical attributes. For example, as described above, in some embodiments the routine 400 can determine if the mobile device 124 is a counterfeit based on whether it detects a reflected beam line 385 (FIG. 3C) or based on the size offset distance d₂ (FIG. 3C) between, e.g., the center beam line segment 312 and the reflected beam line 385. In additional or alternate embodiments, the routine 400 can use a 3D model or profile to identify, authenticate, and/or assess the mobile device 124. In one aspect of this embodiment, the routine 400 can use the 3D model to obtain various two-dimensional and/or three-dimensional views of the mobile device 124 at a desired scale and/or vantage point. For example, the routine 400 can rotate, zoom, pan, and/or otherwise manipulate the 3D model to evaluate a particular region of interest on the mobile device 124, such as a potentially damaged region.

Once the kiosk 100 completes its inspection of the mobile device 124, the user can be presented with a purchase price via the display screen 104 (FIG. 1). In some embodiments, the kiosk 100 can determine an estimated price or an estimated range of prices to offer a customer for the mobile device 124 based on the identification and/or evaluation (e.g., the presence of damage) to the mobile device 124. In these and other embodiments, the kiosk processor 290 (FIG. 2A) may query a database comprising a lookup table with various prices for a range of identified electronic devices depending on their evaluated conditions. As one example, the lookup table may indicate that for a particular smartphone make and model, three different prices are available depending on the determined condition (e.g., poor condition —$100, fair condition—$200, good condition—$300). The kiosk processor 290 may grade the condition of the smartphone automatically based on the visual and/or electrical inspection. Based on the graded condition of the mobile device 124, the kiosk processor 290 may query a database and receive a compensation amount to be offered to the customer. In some embodiments, the price may not depend on the condition of the electronic device, but only on the make and model. Additional details relating to processes for determining the price for an electronic device are disclosed in commonly owned U.S. patent application Ser. No. 14/498,763.

If the user declines the price (via, e.g., the touchscreen), a retraction mechanism of the kiosk 100 automatically disconnects the connector 254 (FIG. 2A) from the mobile device 124, the door 106 (FIG. 1) opens, and the user can reach in and retrieve the mobile device 124. If the user accepts the price, the door 106 remains closed, and the kiosk 100 collects the mobile device 124 for recycling. Referring to FIG. 2A, in some embodiments, the kiosk 100 can include components configured to facilitate collection of electronic devices in a collection bin 252 within the kiosk 100. For example, the upper chamber 234 can be operably coupled to a gate 250 configured to move up and down in unison with the upper chamber 234. When the upper chamber 234 is in the lower position, the inspection plate 244 is permitted to slide underneath the gate 250 and below the chamber 234, but not electronic devices carried on the plate. As a result, the gate 250 knocks the electronic devices off of the inspection plate 244 and into the collection bin 252.

Once the mobile device 124 is collected in the bin 252, the kiosk can then provide payment of the purchase price to the user. In some embodiments, payment can be made in the form of cash dispensed from the cash outlet 118. In other embodiments, the user can receive remuneration for the mobile device 124 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet, etc.), Bitcoin, etc.

As those of ordinary skill in the art will appreciate, the foregoing process is but one example of a way in which the kiosk 100 can be used to recycle or otherwise process consumer electronic devices, such as mobile phones. Although the foregoing example is described in the context of mobile phones, it should be understood that kiosk 100 and various embodiments thereof can also be used in a similar manner for recycling virtually any consumer electronic device, such as MP3 players, tablet computers, PDAs, and other portable devices, as well as other relatively non-portable electronic devices such as desktop computers, printers, devices for playing games, entertainment or other digital media on CDs, DVDs, Blu-ray, etc. Moreover, although the foregoing example is described in the context of use by a consumer, the kiosk 100 in various embodiments thereof can similarly be used by others, such as store clerk, to assist consumers in recycling, selling, exchanging, etc. their electronic devices.

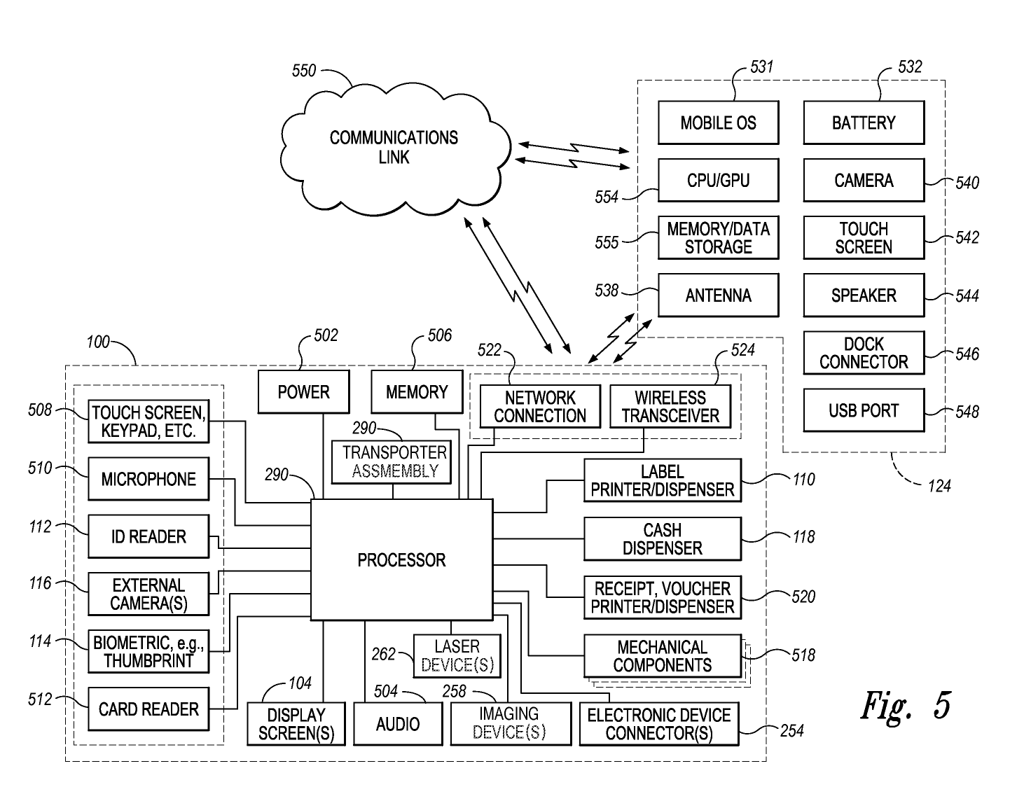

FIG. 5 provides a schematic representation of an architecture of the kiosk 100 configured in accordance with an embodiment of the present technology. In the illustrated embodiment, the kiosk processor 290 controls operation of the kiosk 100 in accordance with computer-readable instructions stored on system memory 506. The kiosk processor 290 may be any logic processing unit, such as one or more CPUs, digital signal processors (DSPs), application-specific integrated circuits (ASICs), etc. The kiosk processor 290 may be a single processing unit or multiple processing units in a device or distributed across multiple devices. The kiosk processor 290 is connected to the memory 506 and may be coupled to other hardware devices, for example, with the use of a bus (e.g., a PCI Express or Serial ATA bus). The kiosk processor 290 can include, by way of example, a standard personal computer (PC) (e.g., a DELL OPTIPLEX 7010 PC) or other type of embedded computer running any suitable operating system, such as Windows, Linux, Android, iOS, or an embedded real-time operating system. In some embodiments, the kiosk processor 290 can be a small form factor PC with integrated hard disk drive (HDD) or solid-state drive (SSD) and universal serial bus (USB) or other ports to communicate with the other components of the kiosk 100. In other embodiments, the kiosk processor 290 can include a microprocessor with a standalone motherboard that interfaces with a separate HDD. The memory 506 can include read-only memory (ROM) and random access memory (RAM) or other storage devices, such as disk drives or SSDs, that store the executable applications, test software, databases and other software required to, for example, control kiosk components, process electronic device information and data (to, e.g., evaluate device make, model, condition, pricing, etc.), communicate and exchange data and information with remote computers and other devices, etc.

The kiosk processor 290 can provide information and instructions to kiosk users via the display screen 104 and/or an audio system (e.g., a speaker) 504. The kiosk processor 290 can also receive user inputs via, e.g., a touchscreen 508 associated with the display screen 104, a keypad with physical keys, and/or a microphone 510. Additionally, the kiosk processor 290 can receive personal identification and/or biometric information associated with users via the ID reader 112, one or more of the external cameras 116, and/or the fingerprint reader 114. In some embodiments, the kiosk processor 290 can also receive information (such as user identification and/or account information) via a card reader 512 (e.g., a debit, credit, or loyalty card reader having, e.g., a suitable magnetic stripe reader, optical reader, etc.). The kiosk processor 290 can also control operation of the label dispenser 110 and systems for providing remuneration to users, such as the cash dispenser 118 and/or a receipt or voucher printer and an associated dispenser 520.

As noted above, the kiosk 100 additionally includes a number of electronic, optical and electromechanical devices for electrically, visually and/or physically analyzing electronic devices placed therein for recycling. Such systems can include the laser device 262, the internal camera 258, and the transporter assembly 232 for performing a visual inspection of the mobile device as discussed above. In at least some embodiments, the kiosk processor 290 can power on/off the laser, process imaging data received from the camera 258, and control the transporter assembly 232 to position the mobile device within the upper chamber 234 (FIG. 2A).

The kiosk 100 can also include one or more of the electrical connectors 254 for, e.g., powering up electronic devices and performing electronic analyses. The kiosk processor 290 can control operation of the connector carrier 256, such as to change which of the connectors 254 is presented to a user. The kiosk 100 further includes a plurality of mechanical components 518 (e.g., the access door 106; FIG. 1) that are electronically actuated for carrying out the various functions of the kiosk 100 during operation. The kiosk 100 further includes power 502, which can include battery power and/or facility power for operation of the various electrical components associated with kiosk operation.

In the illustrated embodiment, the kiosk 100 further includes a network connection 522 (e.g., a wired connection, such as an Ethernet port, cable modem, FireWire cable, Lightning connector, USB port, etc.) suitable for communication with, e.g., all manner of remote processing devices via a communication link 550, and a wireless transceiver 524 (e.g., including a Wi-Fi access point, Bluetooth transceiver, near-field communication (NFC) device, and/or a wireless modem or cellular radio utilizing GSM, CDMA, 3G, and/or 4G technologies, each of which may include an associated antenna or antennas) for data communications suitable for communication with, e.g., all manner of remote processing devices via the communication link 550 and/or directly via, e.g., a wireless peer-to-peer connection. For example, the wireless transceiver 524 can facilitate wireless communication with handheld devices, such as the mobile device 124, either in the proximity of the kiosk 100 or remote therefrom. By way of example only, in the illustrated embodiment the mobile device 124 can include one or more features, applications and/or other elements commonly found in smartphones and other known mobile devices. For example, the mobile device 124 can include a CPU and/or a graphics processing unit (GPU) 554 for executing computer readable instructions stored on memory 555. In addition, the mobile device 124 can include an internal power source or battery 532, a dock connector 546, a USB port 548, a camera 540, and/or well-known input devices, including, for example, a touchscreen 542, a keypad, etc. In many embodiments, the mobile device 124 can also include a speaker 544 for two-way communication and audio playback. In addition to the foregoing features, the mobile device 124 can include a mobile operating system (OS) 531 and/or a device wireless transceiver that may include one or more antennas 538 for wirelessly communicating with, for example, other mobile devices, websites, and the kiosk 100. Such communication can be performed via, e.g., the communication link 550 (which can include the Internet, a public or private intranet, a local or extended Wi-Fi network, cell towers, the plain old telephone system (POTS), etc.), direct wireless communication, etc.

Unless described otherwise, the construction and operation of the various components shown in FIG. 5 are of conventional design. As a result, such components need not be described in further detail herein, as they will be readily understood by those skilled in the relevant art. In other embodiments, the kiosk 100 and/or the mobile device 124 can include other features that may be different from those described above. In still further embodiments, the kiosk 100 and/or the mobile device 124 can include more or fewer features similar to those described above.

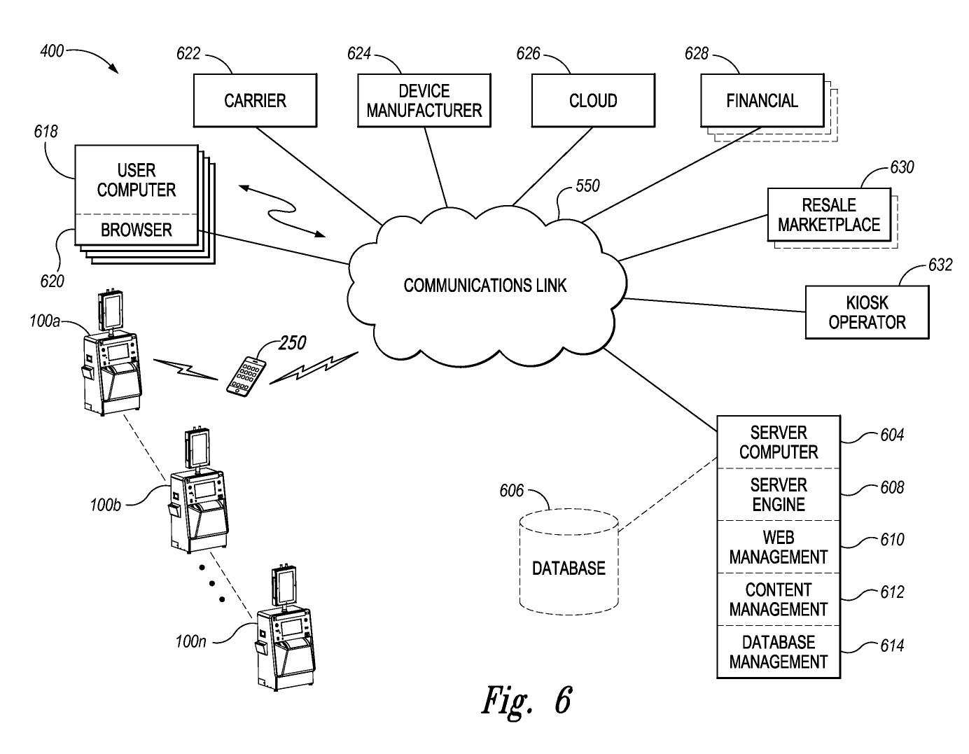

FIG. 6 is a schematic diagram of a suitable network environment for implementing various aspects of an electronic device recycling system 600 configured in accordance with embodiments of the present technology. In the illustrated embodiment, a plurality of the kiosks 100 (identified individually as kiosks 100a-100n) can exchange information with one or more remote computers (e.g., one or more server computers 604) via the communication link 550. Although the communication link 550 can include a publically available network (e.g., the Internet with a web interface), a private communication link, such as an intranet or other network can also be used. Moreover, in various embodiments the individual kiosk 100 can be connected to a host computer (not shown) that facilitates the exchange of information between the kiosks 100 and remote computers, other kiosks, mobile devices, etc.

The server computer 604 can perform many or all of the functions for receiving, routing and storing of electronic messages, such as webpages, audio signals and electronic images necessary to implement the various electronic transactions described herein. For example, the server computer 604 can retrieve and exchange web pages and other content with an associated database or databases 606. In some embodiments, the database 606 can include information related to mobile phones and/or other consumer electronic devices. Such information can include, for example, make, model, serial number, International Mobile Equipment Identity (IMEI) number, carrier plan information, pricing information, owner information, etc. In various embodiments the server computer 604 can also include a server engine 608, a web page management component 610, a content management component 612, and a database management component 614. The server engine 608 can perform the basic processing and operating system level tasks associated with the various technologies described herein. The webpage management component 610 can handle creation and/or display and/or routing of web or other display pages. The content management component 612 can handle many of the functions associated with the routines described herein. The database management component 614 can perform various storage, retrieval and query tasks associated with the database 606, and can store various information and data such as animation, graphics, visual and audio signals, etc.

In the illustrated embodiment, the kiosks 100 can also be operably connected to a plurality of other remote devices and systems via the communication link 550. For example, the kiosks 100 can be operably connected to a plurality of user devices 618 (e.g., personal computers, laptops, handheld devices, etc.) having associated browsers 620. Similarly, as described above the kiosks 100 can each include wireless communication facilities for exchanging digital information with mobile devices, such as the mobile device 124. The kiosks 100 and/or the server computer 604 are also operably connectable to a series of remote computers for obtaining data and/or exchanging information with necessary service providers, financial institutions, device manufactures, authorities, government agencies, etc. For example, the kiosks 100 and the server computer 604 can be operably connected to one or more cell carriers 622, one or more device manufacturers 624 (e.g., mobile phone manufacturers), one or more electronic payment or financial institutions 628, one or more databases (e.g., the GSMA IMEI Database, etc.), and one or more computers and/or other remotely located or shared resources associated with cloud computing 626. The financial institutions 628 can include all manner of entity associated with conducting financial transactions, including banks, credit/debit card facilities, online commerce facilities, online payment systems, virtual cash systems, money transfer systems, etc.

In addition to the foregoing, the kiosks 100 and the server computer 604 can also be operably connected to a resale marketplace 630 and a kiosk operator 632. The resale marketplace 630 represents a system of remote computers and/or services providers associated with the reselling of consumer electronic devices through both electronic and brick and mortar channels. Such entities and facilities can be associated with, for example, online auctions for reselling used electronic devices as well as for establishing market prices for such devices. The kiosk operator 632 can be a central computer or system of computers for controlling all manner of operation of the network of kiosks 100. Such operations can include, for example, remote monitoring and facilitating of kiosk maintenance (e.g., remote testing of kiosk functionality, downloading operational software and updates, etc.), servicing (e.g., periodic replenishing of cash and other consumables), performance, etc. In addition, the kiosk operator 632 can further include one or more display screens operably connected to cameras located at each of the kiosks 100 (e.g., one or more of the cameras 116 described above with reference to FIG. 1). This remote viewing capability enables operator personnel to verify user identification and/or make other visual observations at the kiosks 100 in real-time during transactions, as described above with reference to FIG. 1.

The foregoing description of the electronic device recycling system 600 illustrates but one possible network system suitable for implementing the various technologies described herein. Accordingly, those of ordinary skill in the art with appreciate that other systems consistent with the present technology can omit one or more of the facilities described in reference to FIG. 6, or can include one or more additional facilities not described in detail in FIG. 6.

The kiosks 100, mobile devices 124, server computers 604, user computers or devices 618, etc. can include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computers can include other program modules such as an operating system, one or more application programs (e.g., word processing or spreadsheet applications), and the like. The computers can include wireless computers, such as mobile phones, personal digital assistants (PDA's), palm-top computers, etc., which communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network, such as an intranet can likewise be used herein. The network can have a client-server architecture, in which a computer is dedicated to serving other client computers, or it can have other architectures such as peer-to-peer, in which one or more computers serve simultaneously as servers and clients. A database or databases, coupled to the server computer(s), stores much of the web pages and content exchanged between the user computers. The server computer(s), including the database(s), can employ security measures to inhibit malicious attacks on the system, and to preserve integrity of the messages and data stored therein (e.g., firewall systems, message encryption and/or authentication (e.g., using transport layer security (TLS) or secure sockets layer (SSL)), password protection schemes, encryption of stored data (e.g., using trusted computing hardware), and the like).

One skilled in the relevant art will appreciate that the concepts of the invention can be used in various environments other than location based or the Internet. In general, a display description can be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, can be used instead of the Internet. The system can be conducted within a single computer environment, rather than a client/server environment. Also, the user computers can comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules can be located in both local and remote memory storage devices.

Aspects of the invention can be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices can include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A kiosk for recycling consumer electronic devices, the kiosk comprising:
a housing configured to receive an electronic device;
a laser device positioned within the housing, wherein the laser device is configured to project a laser beam that forms a laser beam line, and wherein at least a portion of the laser beam line extends across at least one exterior surface of the electronic device;
an imaging device positioned within the housing and configured to acquire imaging data corresponding to physical attributes of the laser beam line;
a processor operably coupled to the imaging device; and
a non-transitory computer readable medium containing instructions that are executable by the processor to determine one or more physical attributes of the electronic device based at least in part on the imaging data.

2. The kiosk of claim 1, further comprising a device transporter positioned within the housing, wherein the device transporter is configured to transport the electronic device from a first position within the housing to a second position within the housing, and wherein the first and second positions are located within a field of view of the imaging device and in a path of the laser beam.

3. The kiosk of claim 1, further comprising a user interface operably coupled to the housing and configured to receive user input associated with a make and/or model of the electronic device, wherein the instructions are executable by the processor to confirm the user input based at least in part on the one or more physical attributes.

4. The kiosk of claim 1, further comprising a user interface operably coupled to the housing and configured to receive user input associated with a make and/or model of the electronic device, wherein the instructions are executable by the processor to:
determine a dimension of the electronic device based at least in part on the one or more physical attributes; and
confirm the user input based at least in part on the dimension.

5. The kiosk of claim 1, further comprising:
a chamber within the housing; and
a device transporter positioned within the chamber, wherein the device transporter is configured to transport the electronic device from a first position within the chamber to a second position with the chamber.

6. The kiosk of claim 1, further comprising:
a chamber within the housing; and
a device transporter positioned within the chamber, wherein the device transporter is configured to transport the electronic device through the field of view of the imaging device and through a path of the laser beam.

7. The kiosk of claim 1 wherein the instructions are executable by the processor to:
construct a 3D profile of the electronic device based at least in part on the one or more physical attributes; and
identify the electronic device based on the 3D profile.

8. The kiosk of claim 1 wherein the laser beam line includes first and second segments, and wherein the instructions are executable by the processor to:
detect a transition point between the first and second segments; and
determine a dimension of the electronic device based at least in part on the transition point.

9. The kiosk of claim 1 wherein the laser beam line includes first, second, third, and fourth segments, and wherein the instructions are executable by the processor to:
detect a first transition point between the first and second segments;
detect a second transition point between the third and fourth segments; and
determine a dimension of the electronic device based at least in part on a distance between the first and second transition points.

10. The kiosk of claim 1 wherein the instructions are executable by the processor to:
detect first and second segments of the laser beam line; and
determine a dimension of the electronic device based at least in part on a distance between the first and second segments.

11. The kiosk of claim 1 wherein the laser beam line includes first and second segments, wherein the electronic device includes a feature located proximate the at least one exterior surface, and wherein the instructions are executable by the processor to determine the location of the feature by locating a transition point between the first and second segments.

12. The kiosk of claim 1 wherein the instructions are executable by the processor to detect a damaged region in the at least one exterior surface based at least in part on a discontinuity in the laser beam line.

13. The kiosk of claim 1 wherein the instructions are executable by the processor to detect a damaged region in the least one exterior surface based at least in part on a region of beam scatter in the laser beam line.

14. The kiosk of claim 1 wherein the imaging device includes a Lidar sensor, and the laser device includes a Lidar scanner.

15. The kiosk of claim 1 wherein the instructions are executable by the processor to:
detect a reflected beam line separate from the laser beam line; and
evaluate the electronic device based at least in part on the reflected beam line.

16. A method for recycling an electronic device, the method comprising:
receiving the electronic device from a user at a kiosk;
illuminating a portion of at least one exterior surface of the electronic device, wherein the illuminated portion forms a line on the exterior surface;
acquiring an image of the line; and
determining one or more physical attributes of the electronic device based at least in part on an evaluation of the image.

17. The method of claim 16, further comprising determining a value of the electronic device based at least in part on the determined physical attributes.

18. The method of claim 16 wherein determining the one or more physical attributes includes implementing with a processor at least one imaging processing algorithm on imaging data associated with the image to detect the line.

19. The method of claim 16 wherein determining the one or more physical attributes includes detecting a dimension of the electronic device, and wherein detecting the dimension region includes implementing with a processor at least one imaging processing algorithm on imaging data associated with the image to detect a transition region between segments of the line.

20. The method of claim 16 wherein determining the one or more physical attributes includes detecting a damaged region in the at least one exterior surface, and wherein detecting the damaged region includes implementing with a processor at least one image processing algorithm on imaging data associated with the image to detect a discontinuity in the line.

21. The method of claim 16 wherein determining the one or more physical attributes includes detecting a damaged region in the at least one exterior surface, wherein detecting the damaged region includes implementing with a processor at least one image processing algorithm on imaging data associated with the image to detect a region of beam scatter in the line.

22. The method of claim 16 wherein illuminating the portion of the at least one exterior surface includes striking the at least one exterior surface with a laser beam.

23. The method of claim 16, further comprising
receiving user input at the kiosk, wherein the laser input is related to the electronic device;
identifying the electronic device based at least in part on the more physical attributes; and
authenticating the electronic device based on the user input and the identification of the device.

24. The method of claim 16 further comprising querying a database for information associated with the physical attributes to determine a make and/or model of the electronic device.

25. The method of claim 16 wherein determining the one or more physical attributes includes detecting the line in the image using an edge detection algorithm.

26. The method of claim 16 wherein acquiring the image of the line includes acquiring multiple images while moving the electronic device relative to a field of view of the imaging device and a path of a laser beam that forms the line.

27. The method of claim 16 wherein acquiring the image includes acquiring an image of a line extending across a top side of the electronic device.

28. The method of claim 16 wherein the electronic device includes a feature located proximate to the at least one exterior surface, and wherein determining the one or more physical attributes includes:
detecting first and second portions of the line in the image; and
determining the location of the feature by detecting a transition point between the first and second portions.

29. The method of claim 16 wherein determining the one or more physical attributes includes:
detecting first and second portions of the line in the image; and
determining a dimension of the electronic device based at least in part on a distance between the first and second portions.

30. The method of claim 16 wherein determining the one or more physical attributes includes detecting damage and/or a defect of the at least one exterior surface based at least in part on the evaluation of the image.

31. The method of claim 16 wherein determining the one or more physical attributes includes detecting a reflected line separate from the laser line, and wherein the method further comprises authenticating the electronic device based at least in part on the detection of the reflected line.

32. A kiosk for recycling electronic devices, the kiosk comprising:
means for receiving an electronic device for a user;
means for forming a laser beam line on an exterior surface of the electronic device;
means for acquiring an image of the laser beam line on the at least one exterior surface; and
a processor for evaluating the laser beam line and determining one or more physical attributes of the electronic device based at least in part on the evaluation.

32. The kiosk of claim 31 wherein the processor is configured to identify the electronic device based at least in part on the one or more physical attributes.
